(19) United States
(12) Patent Application Publication
(10) Pub. No.: US 2026/0185553 A1
(43) Pub. Date: Jul. 2, 2026

(54) REINFORCEMENT QUICK NUT

(71) Applicant: Fulian Precision Electronics (Tianjin) Co., LTD., Tianjin (CN)

(72) Inventors: CHIA-HSIU WU, New Taipei (TW); CHANG-HSIEN CHEN, New Taipei (TW)

(21) Appl. No.: 19/066,500

(22) Filed: Feb. 28, 2025

(30) Foreign Application Priority Data
Dec. 31, 2024 (CN) 202411979568.2

(51) Int. Cl. F16B 37/08

(52) U.S. Cl. CPC F16B 37/08

(57) ABSTRACT

A reinforcement quick nut consists of a main body with opposing first and second surfaces. Inside the main body, a threaded hole traverses these two surfaces. The inner wall of the threaded hole has a thread. The threaded hole includes a straight hole and an oblique hole, with partial overlap. The straight hole has a first center axis perpendicular to the first surface, while the oblique hole has a second center axis inclined relative to the first. In the first center axis, the height of the straight hole exceeds 30 millimeters.

### FIELD

The subject matter herein generally relates to the mechanical connections, and more particularly, to a reinforcement quick nut.

### BACKGROUND

Quick nuts may be engaged with screw bolts to realize a detachable connection. The quick nut may adopt a tapered partial thread, where the threads are only partially engaged and are angled or tapered to facilitate rapid engagement and disengagement with a bolt. However, with the tapered partial thread design, the quick nut may be loosened and separated from the screw bolt under high vibration or when the quick nut is mounted on a slightly uneven mounting surface, thereby affecting the stability and safety of the connection.

### BRIEF DESCRIPTION OF THE DRAWINGS

Implementations of the present technology will now be described, by way of example only, with reference to the attached figures.

FIG. 1 is a schematic view of a reinforcement quick nut according to an embodiment of the present disclosure.

FIG. 2 is a top view of the reinforcement quick nut shown in FIG. 1.

FIG. 3 is a side view of the reinforcement quick nut shown in FIG. 1.

FIG. 4 is a cross-sectional view taken along line A-A of the reinforcement quick nut shown in FIG. 1.

FIG. 5 is similar to FIG. 4, but showing the cross-sectional view of a reinforcement quick nut according to another embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

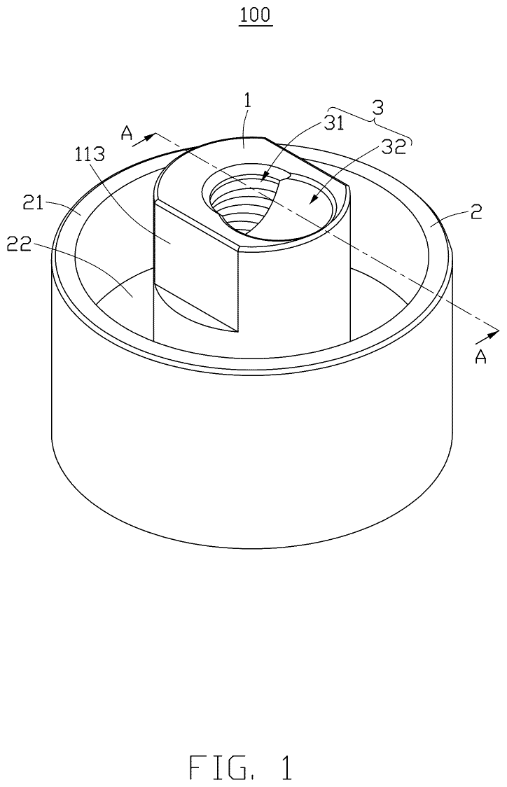

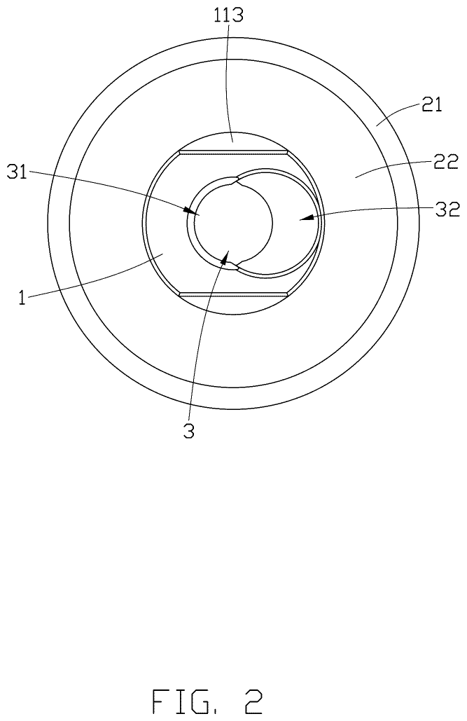

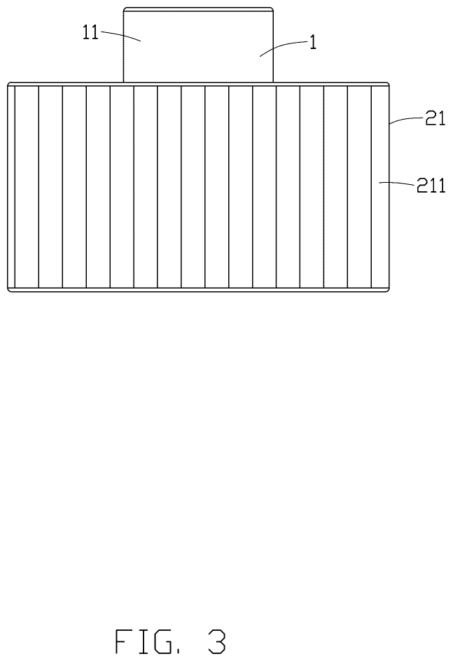

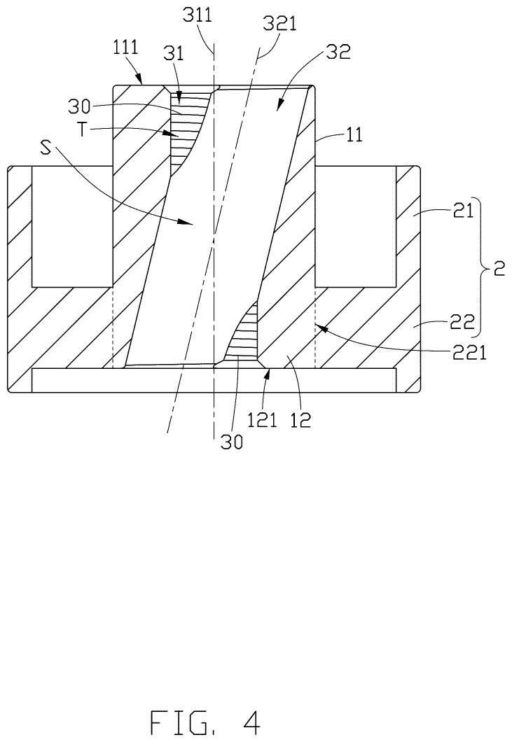

Referring to FIGS. 1, 2, 3, and 4, a reinforced quick nut 100 is provided according to one embodiments of the present disclosure. The reinforced quick nut 100 includes a nut main body 1 and a nut seat body 2. The nut main body 1 is substantially cylindrical, and the nut seat body 2 is substantially tubular. The nut seat body 2 is disposed around an outer side of the nut main body 1. The nut seat body 2 includes an outer sleeve portion 21 and a connection portion 22. The connection portion 22 is provided inside the outer sleeve portion 21, and the connection portion 22 is provided with a through hole 221. The nut main body 1 extends through the through hole 221. The nut main body 1 matches the through hole 221, and an edge of the nut main body 1 is connected to the connection portion 22 to form the overall structure of the reinforced quick nut 100.

The cross-sectional shape of the nut main body 1 may be regular hexagonal, regular quadrilateral, circular, or an elliptical to allow the reinforcement quick nut 100 to adapt to different mounting tools or application scenarios. The cross-sectional shape of the nut seat body 2 may be cuboid, cylindrical, or prismatic to allow the reinforcement quick nut 100 to satisfy diverse usage requirements.

The nut main body 1 includes a first end 11 and a second end 12 opposite to the first end 11. The first end 11 protrudes beyond the outer sleeve portion 21, and the second end 12 is accommodated within the outer sleeve portion 21. The nut seat body 2 is capable of enhancing the overall stability of the reinforcement quick nut 100 so as to ensure reliability of the connection of the reinforcement quick nut 100 under complex working conditions. Specifically, the outer sleeve portion 21 provides lateral support and constraint for the nut main body 1. When the reinforcement quick nut 100 is subjected to external lateral impact forces or vibration, the outer sleeve portion 21 is capable of dispersing such forces to prevent the nut main body 1 from tilting or loosening due to uneven loading. For example, during the vibration generated in industrial equipment operation, the outer sleeve portion 21 serves as a stable shield, such that the nut main body 1 maintains the correct axial position and in tight connection the screw bolt.

In this embodiment, the nut main body 1 and the nut seat body 2 are integrally formed. The reinforcement quick nut 100 is made of bearing steel such as GCr15, or high-strength alloy steel such as 40CrNiMoA, or precipitation-hardening stainless steel such as 17-4PH, or titanium alloy such as TC 4, or other high-strength materials, so that the reinforcement quick nut 100 is capable of adapting to a variety of complex and demanding working environments and operating conditions. In other embodiments, at least one of the connection portion 22 and the outer sleeve portion 21 may also be made of a flexible material, such as rubber or silicone, which have excellent elasticity and flexibility. Such materials have high deformability. When subjected to external force, the nut seat body 2 can be deformed. In this way, when the reinforcement quick nut 100 is used in a complex mounting environment, for example, when the mounting surface is slightly uneven or has a certain angle of inclination, at least one of the connection portion 22 and the outer sleeve portion 21 can change the shape due to the flexible characteristics. For example, at least one of the connection portion 22 and the outer sleeve portion 21 can be bent or twisted within a certain range, thereby slightly adjusting the relative position of the outer sleeve portion 21 and/or the outer sleeve portion 21 with respect to the nut main body 1, and ensuring coaxiality between the nut main body 1 and the screw bolt to achieve a stable and reliable connection. Even under long-term vibration or external impact, at least one of the flexible connection portion 22 and the outer sleeve portion 21 can absorb a part of the energy through deformation, thereby reducing any adverse effect on the fastening state of the nut main body 1, and further enhancing the adaptability and connection stability of the entire reinforcement quick nut 100 under different working conditions.

In the present embodiment, the first end 11 of the nut main body 1 has a first surface 111 that is away from the second end 12, and the second end 12 has a second surface 112 away from the first surface 111. A threaded hole 3 is provided in the nut main body 1, and the threaded hole 3 passes through the first surface 111 and the second surface 112. The threaded hole 3 includes a straight hole 31 and an oblique hole 32. The straight hole 31 and the oblique hole 32 partially overlap. The straight hole 31 has a first center axis 311, and the oblique hole 32 has a second center axis 321. The first center axis 311 and the second center axis 321 intersect with each other, and the angle therebetween is in a range of 12° and 15°. Screw threads 30 are provided on the inner wall of the straight hole 31.

In use, when the screw bolt is inserted into the threaded hole 3, the presence of the oblique hole 32 causes a head of the screw bolt to be guided quickly along the oblique hole 32 into the straight hole 31, and because the first center axis 311 intersects with the second center axis 321, the head of the screw bolt is capable of moving along the oblique hole 32 into the straight hole 31. That is, the oblique hole 32 acts like an entrance with a guiding path, which facilitates the screw bolt to enter the straight hole 31. Moreover, because there is an angle between the first center axis 311 and the second center axis 321 in the range of 12° to 15°, once the screw bolt enters the straight hole 31, a certain preload is produced on the screw bolt. Such preload is capable of providing a certain level of connection tightness at the initial installation stage of the screw bolt and the reinforcement quick nut 100, thereby reducing the loosening between the screw bolt and the reinforcement quick nut 100.

In other embodiments of the present application, the first center axis 311 and the second center axis 321 do not intersect with each other, i.e., the first center axis 311 and the second center axis 321 are within different planes. When subjected to vibration or external unstable forces, the screw bolt is not easily loosened within the threaded hole 3. When the first center axis 311 and the second center axis 321 are within different planes, constraint are produced along more directions with respect to the screw bolt in the threaded hole 3. Such a complex constraint allows the reinforcement quick nut 100 to resist against the vibration and external forces from various directions, thereby improving the anti-loosening performance of the reinforcement quick nut 100.

In the present embodiment, a region where the straight hole 31 and the oblique hole 32 overlap is located near the midpoint of the straight hole 31, i.e., the straight hole 31 and the oblique hole 32 cross and overlap with each other. The overlapping portion of the straight hole 31 and the oblique hole 32 is defined as a first region S, and the straight hole 31 further includes a second region T out of the first region S. The screw thread 30 is provided in the second region T. In this way, when the screw bolt is inserted into the threaded hole 3, during the initial stage, the screw bolt is capable of smoothly entering the first region S of the straight hole 31 along the inclination direction of the oblique hole 32, and the oblique hole 32 performs guiding and transition functions, thereby reducing any jamming or frictional resistance that occurs in the insertion process, and making installation operations more convenient and faster. Moreover, since the overlapping location is near the midpoint of the straight hole 31, in the further tightening stage of the bolt, as the screw bolt moves deeper into the straight hole 31, a contact length between the screw bolt and the screw thread 30 provided at both upper and lower ends of the straight hole 31 is uniform, thereby allowing the axial tension and torque to be evenly distributed, and reducing the loosening of the reinforcement quick nut 100 or damages to the screw thread 30 caused by uneven loading.

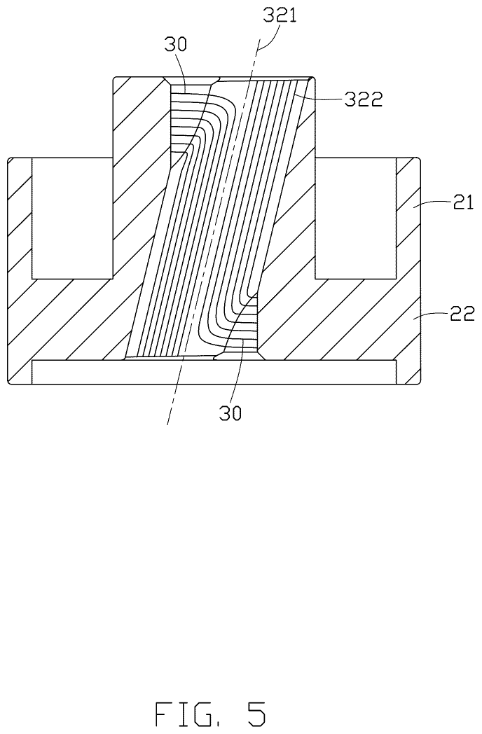

Referring to FIG. 5, in another embodiment of the present application, multiple stripes 322 are arranged at intervals inside the oblique hole 32. The multiple stripes 322 are arranged in parallel, and each stripe 322 at least partially extends along the second center axis 321. Two ends of each stripe 322 is smoothly connected to one screw thread 30. Thus, in the installation process of the reinforcement quick nut 100 onto the screw bolt, the existence of the stripes 322 reduces the contact area between the screw bolt and the inner wall of the oblique hole 32, thereby further increasing the sliding speed of the reinforcement quick nut 100 on the screw bolt. Consequently, the reinforcement quick nut 100 is capable of moving more quickly along the screw bolt to a predetermined position. Since the stripes 322 are connected to the screw threads 30, during the tightening process of the reinforcement quick nut 100, the stripes 322 are capable of playing a guiding role, enabling the reinforcement quick nut 100 to be screwed more accurately along the thread trajectory of the screw bolt, and reducing problems such as insecure connection or uneven force caused by installation deviations.

In the present embodiment, an inner diameter D1 of the straight hole 31 is greater than an inner diameter D2 of the oblique hole 32. The inner diameter D1 of the straight hole 31 is in a range of 18 mm and 22 mm, and the inner diameter D2 of the oblique hole 32 is in a range of 12 mm and 16 mm. For example, the inner diameter of the straight hole 31 is 20 mm, and the inner diameter of the oblique hole 32 is 14 mm. When the screw bolt is installed, the larger-diameter straight hole 31 provides a relatively wide initial entry space for the screw bolt, making the screw bolt easier to align with and insert into the reinforcement quick nut 100. Meanwhile, the smaller-diameter oblique hole 32 serves a guidance and positioning function during the screw bolt enters the straight hole 31, such that the screw bolt can accurately follow the desired path into the straight hole 31, and reducing the damages to the screw thread 30 or poor connection caused by insertion errors.

In the present embodiment, the height of the straight hole 31 is greater than 30 mm. The screw thread 30 is disposed on an inner wall of the straight hole 31. In the direction of the first center axis 311, the travel of the screw thread 30 is greater than 30 mm. The pitch of the screw threads 30 is in a range of 1.6 to 2.0 mm. Within a length of 13.7 mm (i.e., ½ inch) of the nut main body 1, the number of the screw threads 30 is in a range of 11 to 15. For example, the number of the screw threads 30 is 13 within a length of 13.7 mm of the nut main body 1. Thus, the contact area between the reinforcement quick nut 100 and the screw thread 30 becomes larger when engaged with each other. More screw thread 30 share the pressure, and the axial tension and torque borne by each screw thread 30 is evenly distributed. Under a large external load, the pressure applied onto each screw thread 30 is reduced, thereby lowering the risk of deformation, wear, or damage to an individual screw thread 30. This is crucial when the reinforcement quick nut 100 is used under high vibration or on uneven mounting surfaces. The relatively deep straight hole 31 provides a deeper loading range, increasing the engaging area between the screw bolt and the screw threads 30. Even when subjected to vibration, impact, or uneven forces due to an uneven mounting surface, the reinforcement quick nut 100 is still capable of maintaining high fastening strength and anti-loosening performance. In other words, the deeper straight hole 31 allows the screw threads 30 to evenly distribute the pressure, and also reduces the loosening of the screw bolt in a long-term vibration environment.

In the present embodiment, a plurality of anti-slip grooves 211 is provided on an outer surface of the outer sleeve portion 21 on the side away from the nut main body 1. The extending direction of each of the anti-slip grooves 211 is parallel to the first center axis 311. The anti-slip grooves 211 are configured to increase the friction between the nut seat body 2 and a mounting tool such as a wrench. When the mounting tool is used to rotate the reinforcement quick nut 100, the anti-slip grooves 211 are capable of preventing the mounting tool from slipping, so that the torque is transmitted more stably to the reinforcement quick nut 100, ensuring smooth tightening or removal of the reinforcement quick nut 100. The anti-slip grooves 211 are especially advantageous in wet, greasy, or other working environments prone to slippage. Additionally, if the reinforcement quick nut 100 is subjected to vibration or external impacts, the anti-slip grooves 211 can also enhance the friction between the nut seat body 2 and the mounting surface, thereby reducing the loosening of the reinforcement quick nut 100 and further improving connection stability.

In the present embodiment, two notches 113 are formed at the first end 11 of the nut main body 1, and the two notches 113 are arranged symmetrically. The two notches 113 are used to facilitate insertion of auxiliary tools for special operations. For instance, in a narrow space or where it is difficult to directly use a conventional wrench, a specially thin tool can be inserted into the notches 113. By rotating this auxiliary tool, the nut main body 1 can be driven to rotate, thereby achieving installation or removal of the reinforcement quick nut 100. Additionally, the two notches 113 can serve as markers or positioning points in certain mechanical assembly processes, so that the correct installation orientation or angle of the reinforcement quick nut 100 can be confirmed, ensuring that the assembly accuracy and performance requirements of the overall mechanical system are satisfied, and improving the efficiency and accuracy of the assembly process.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A reinforcement quick nut, comprising:
a nut main body, wherein the nut main body comprises a first surface and a second surface opposite to each other, the nut main body defines a threaded hole extending through the first surface and the second surface and screw threads provided on an inner wall of the threaded hole,
wherein the threaded hole comprises a straight hole and an oblique hole connected to the straight hole, the straight hole defines a first center axis, the oblique hole defines a second center axis, the first center axis is perpendicular to the first surface, the second center axis is inclined relative to the first center axis, and in a direction of the first center axis, a height of the straight hole is greater than 30 millimeters.

2. The reinforcement quick nut according to claim 1, wherein the screw threads are formed on an inner wall of the straight hole, and a pitch of the screw threads is in a range from 1.6 millimeters to 2.0 millimeters.

3. The reinforcement quick nut according to claim 1, wherein an included angle between the first center axis and the second center axis is in a range from 12° to 15°.

4. The reinforcement quick nut according to claim 3, wherein the included angle is 13.5°.

5. The reinforcement quick nut according to claim 1, wherein an inner diameter of the straight hole is in a range from 18 millimeters to 22 millimeters, and an inner diameter of the oblique hole is in a range from 12 millimeters to 16 millimeters.

6. The reinforcement quick nut according to claim 5, wherein the inner diameter of the straight hole is 20 millimeters, and the inner diameter of the oblique hole is 14 millimeters.

7. The reinforcement quick nut according to claim 1, further comprising a seat body, wherein the seat body comprises an outer sleeve portion and a connection portion, the outer sleeve portion is disposed around an outer side of the connection portion, the connection portion is provided with a through hole, and the nut main body extends through the through hole.

8. The reinforcement quick nut according to claim 7, wherein the seat body has a cross-sectional shape of cuboid, cylindrical, or prismatic.

9. The reinforcement quick nut according to claim 7, wherein a plurality of anti-slip grooves is formed on a side of the outer sleeve portion away from the nut main body, and an extending direction of each of the plurality of anti-slip grooves is parallel to the first center axis.

10. The reinforcement quick nut according to claim 8, wherein the first surface protrudes beyond the outer sleeve portion, and the second surface is located in the outer sleeve portion.

11. The reinforcement quick nut according to claim 10, wherein two notches are formed at an end of the nut main body adjacent to the first surface, and the two notches are arranged symmetrically.

12. The reinforcement quick nut according to claim 1, wherein the reinforcement quick nut is made of bearing steel.

13. The reinforcement quick nut according to claim 12, wherein the nut main body is made of metal or alloy.

14. The reinforcement quick nut according to claim 12, wherein at least one of the connection portion and the outer sleeve portion is made of rubber or silicone.

15. The reinforcement quick nut according to claim 1, wherein the first center axis and the second center axis do not intersect with each other.

16. The reinforcement quick nut according to claim 1, wherein a quantity of the screw threads is 11 to 15 in a length of 13.7 millimeters in the straight hole.

17. The reinforcement quick nut according to claim 1, wherein the nut main body has a cross-sectional shape of a regular hexagonal, a regular quadrilateral, a circular, or an elliptical.

18. The reinforcement quick nut according to claim 1, wherein a plurality of stripes is provided on an inner wall of the oblique hole, and one end of each of the plurality of stripes is connected to one of the screw threads.

19. The reinforcement quick nut according to claim 6, wherein the nut main body and the seat body are integrally formed.
